(19) United States
(12) Patent Application Publication
(10) Pub. No.: US 2026/0151929 A1
(43) Pub. Date: Jun. 4, 2026

(54) HANDHELD POWER TOOL WITH AN ACTUATOR MECHANISM

(71) Applicant: HUSQVARNA AB, Huskvarna (SE)

(72) Inventors: Jonas BERGNER, Huskvarna (SE); Bjorn ROSBERG, Huskvarna (SE); Hilda LINDSTRAND, Huskvarna (SE)

(21) Appl. No.: 19/132,017

(22) PCT Filed: Oct. 10, 2023
(86) PCT No.: PCT/SE2023/051014

§ 371 Date: May 22, 2025

(30) Foreign Application Priority Data
Nov. 23, 2022 (SE) 2251371-7

(51) Int. Cl. B27B 17/02; F02M 1/02

(52) U.S. Cl. CPC B27B 17/02; F02M 1/02

(57) ABSTRACT

A handheld power tool (1) is disclosed comprising an actuator mechanism (4) which comprises a first mechanism member (11) comprising a button unit (5) and a guide unit (7), and a second mechanism member (12) attached to a tool body (3). The first mechanism member (11) is pivotally attached to the second mechanism member (12) between a deactivating position and an activating position. The first and second mechanism members (11, 12) form a locking mechanism (6) configured to allow the first mechanism member (11) to pivot from the deactivating position to the activating position when the button unit (5) is in an unlocking position. The button unit (5) is slidably arranged relative to the guide unit (7) from a locking position towards the unlocking position in a first direction (d1) pointing towards the tool body (3).

### TECHNICAL FIELD

The present disclosure relates to a handheld power tool comprising an actuator mechanism arranged on a tool body of the handheld power tool.

### BACKGROUND

A handheld power tool is a tool intended to be supported by one or two hands of a user during operation. Moreover, a handheld power tool comprises a tool which can be driven by a power source other than solely manual labour. The power source may for example comprise a combustion engine, an electric motor, a pneumatic motor, or the like.

Today, there are many kinds of power tools available on the market. Examples are chainsaws, circular saws, jigsaws, trimmers, hedge trimmers, string-trimmers, brush-cutters, multi-tools, and the like. Power tools are for example used in industry, in construction, in gardens, for housework tasks, and around houses for purposes of cutting, shaping, sanding, grinding, routing, polishing, and the like.

A handheld power tool comprises one or more handles, wherein the handheld power tool is configured to be supported via the one or more handles during operation. Moreover, many handheld power tools comprise a throttle actuator arranged on, or at, one of the handles, wherein the operation of the power source can be controlled via the throttle actuator.

Handheld power tools of various kind are associated with some mutual problems. One problem is safety. That is, a power tool can comprise a sharp tool and a powerful power source for powering the tool, which poses a safety risk.

Partly as a reason thereof, in some jurisdictions, there may be legal requirements specifying that at least some types of handheld power tools must be provided with some kind of activation mechanism which needs to be actuated by a user before the handheld power tool can be operated using a throttle actuator arranged on, or at, a handle of the handheld power tool.

Moreover, in some jurisdictions, and for some types of handheld power tools, there may be legal requirements specifying that such an activation mechanism must require movement in two different directions by a user before the handheld power tool can be operated.

A further general problem when designing power tools and associated components and assemblies is user-friendliness. That is, it is an advantage if the handheld power tool, and associated components and assemblies, are designed such that a user can operate and use the power tool in a simple and intuitive manner.

Another problem is ergonomics. That is, it is an advantage if a handheld power tool can be designed to be operated and used in a convenient and ergonomic manner.

In addition, generally, on today's consumer market, it is an advantage if products comprise different features and functions while the products have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a handheld power tool comprising a tool body, an actuator mechanism arranged on the tool body, and a power source for powering a tool of the handheld power tool, wherein the actuator mechanism comprises a first mechanism member comprising a button unit and a guide unit, and a second mechanism member attached to the tool body. The first mechanism member is pivotally attached to the second mechanism member around a pivot axis between a deactivating position and an activating position and is operably connected to a portion of the power source such that the power source is put in an at least partially deactivated state when the first mechanism member is positioned in the deactivating position and such that the power source is put in an activated state when the first mechanism member is positioned in the activating position. The first and second mechanism members form a locking mechanism configured to lock the first mechanism member from pivoting around the pivot axis in a first pivoting direction from the deactivating position when the button unit is in a locking position and is configured to allow the first mechanism member to pivot in the first pivoting direction from the deactivating position to the activating position when the button unit is in an unlocking position. The button unit is slidably arranged relative to the guide unit from the locking position towards the unlocking position in a first direction pointing towards the tool body.

Thereby, a handheld power tool is provided comprising an actuator mechanism requiring movement of the button unit along two different directions for putting the power source in the activated state, while having conditions for being used in a simple, ergonomic, and intuitive manner. In other words, a handheld power tool is provided comprising a safe actuator mechanism capable of fulfilling legal requirements while having conditions for being used in a simple, ergonomic, and intuitive manner.

In more detail, since the button unit is slidably arranged relative to the guide unit from the locking position towards the unlocking position in the first direction pointing towards the tool body, the first mechanism member is locked from pivoting in the first pivoting direction from the deactivating position before the button unit has been pressed in the first direction from the locking position to the unlocking position. Accordingly, a user of the handheld power tool needs to press the button unit in the first direction pointing towards the tool body and then pivot the first mechanism member, including the button unit, around the pivot axis in order to the put power source is put in the activated state. In this manner, handheld power tool is provided comprising a safe actuator mechanism capable of fulfilling legal requirements.

Moreover, since the power source of the handheld power tool can be put in the activated state by pressing the button unit in the first direction, which points towards the tool body, and then pivot the button unit around the pivot axis, the actuator mechanism can be used in a simple, ergonomic, user-friendly, and intuitive manner.

Some prior art solutions require a user to pull a knob in a direction out from the tool body of the handheld power tool and then move the knob in the direction up or down in a pivoting movement relative to the tool body. As compared to such solutions, the requirement of pressing the button unit along the first direction pointing towards the tool body according to the embodiments herein provides a more ergonomic, user-friendly, and intuitive solution for allowing users to put the power source of the handheld power tool in the activated state.

Moreover, since the actuator mechanism is configured to put the power source in the activated state when the first mechanism member, which includes the button unit, is pivoted to the activating position, an intuitive and user-friendly actuator mechanism is provided because a user can recognise whether the power source is in the activated or deactivated state simply by monitoring the pivoting position of the first mechanism member, and/or the pivoting position of button unit, relative to the tool body.

Accordingly, a handheld power tool is provided overcoming, or at least alleviating, at least some of the above-mentioned problems and drawbacks. As a result, the above-mentioned object is achieved.

Optionally, the first direction is substantially perpendicular to the pivot axis. Thereby, a handheld power tool is provided comprising an actuator mechanism which can be used in an even further simpler and more intuitive manner. This is because a user is allowed to put the power source in the activated state simply by pressing the button unit in the first direction and then pivot the first mechanism member by pivoting the button unit around the pivot axis being substantially perpendicular to the pivot axis.

Moreover, due to these features, a handheld power tool is provided comprising an actuator mechanism having conditions for putting the power source in the activated state using one hand, or one finger of a hand, in a simple, reliable, ergonomic, and intuitive manner.

Optionally, the locking mechanism is formed by a protrusion arranged on the button unit and a recess arranged on the second mechanism member. Thereby, a handheld power tool is provided comprising an actuator mechanism having conditions and characteristics suitable for being manufactured and assembled in a cost-efficient manner, while it has conditions for providing a safe and reliable lock of the first mechanism member in the deactivating position when the button unit is in the locking position.

Optionally, the protrusion is configured to protrude into the recess when the button unit is in the locking position to lock the first mechanism member from pivoting around the pivot axis in the first pivoting direction by an abutting contact between the protrusion and a first side wall of the recess and is configured to be moved out from the recess when the button unit is moved to the unlocking position to allow the first mechanism member to pivot around the pivot axis in the first pivoting direction. Thereby, a handheld power tool is provided comprising an actuator mechanism having conditions for providing a safe and reliable lock of the first mechanism member from pivoting around the pivot axis in the first pivoting direction from the deactivating position when the button unit is in the locking position while it has conditions and characteristics suitable for being manufactured and assembled in a cost-efficient manner.

Moreover, it can be ensured that the locking mechanism becomes unlocked in a simple, efficient, and reliable manner when the button unit is pressed in the first direction. Accordingly, in this manner, it can be ensured that the first mechanism member is allowed to be pivoted around the pivot axis in the first pivoting direction when wanting to put the power source in the activated state.

Optionally, the button unit is configured to be retained in the unlocking position by an abutting contact between the protrusion and a surface of the second mechanism member when the first mechanism member is in the activating position. Thereby, a simple, efficient, and reliable solution is provided for retaining the button unit in the unlocking position. Moreover, in this manner, a more intuitive and user-friendly actuator mechanism is provided because a user can recognise whether the power source is in the activated or deactivated state simply by monitoring the position of the button unit.

Optionally, the actuator mechanism comprises a resilient element configured to bias the button unit in a second direction being opposite to the first direction. Thereby, a handheld power tool is provided comprising an even safer and more reliable actuator mechanism. This is because it can be ensured that the button unit remains in the locked position when the first mechanism member is in the deactivating position and no pressing force is acting on the button unit in the first direction. In other words, due to these features, it can be ensured that the power source remains in the deactivated state until a pressing force is applied onto the button unit which overcomes the biasing force of the resilient element.

Moreover, due to the biasing force of the resilient element, it can be ensured that the first mechanism member remains in the activated position when the button unit has been pressed to the unlocking position, the first mechanism member has been pivoted to the activating position, and a user has released the pressing force onto the button unit. This is because the biasing force of the resilient element can provide a stronger abutting contact between the protrusion and the surface of the second mechanism member when the first mechanism member is in the activating position. Thus, also for this reason, a more reliable and user-friendly actuator mechanism is provided.

Optionally, the power source is an internal combustion engine comprising a choke valve, and wherein the portion of the power source is a choke valve actuator connected to the choke valve of the internal combustion engine. Thereby, a handheld power tool is provided comprising an actuator mechanism which can be used in a simple, reliable, ergonomic, user-friendly, and intuitive manner for controlling the position of the choke valve of the internal combustion engine of the handheld power tool.

Optionally, the locking mechanism allows the first mechanism member to pivot from the deactivating position in a second pivoting direction, being opposite to the first pivoting direction, when the button unit is in the locking position. Thereby, conditions are provided for adding additional functionality controlled via the actuator mechanism of the handheld power tool. In other words, conditions are provided for adding features and functionality controlled via the actuator mechanism in a simple, reliable, ergonomic, user-friendly, and intuitive manner.

Optionally, the actuator mechanism comprises a switch configured to be triggered when the first mechanism member is pivoted from the deactivating position in a second pivoting direction, being opposite to the first pivoting direction, to a stop position. Thereby, conditions are provided for adding additional functionality to the handheld power tool in which one or more aspects of the handheld power tool can be controlled simply by pivoting the first mechanism member in the second pivoting direction to the stop position to thereby trigger the switch.

Optionally, the switch is configured to render the power source inoperable upon being triggered. Thereby, a handheld power tool is provided comprising an actuator mechanism which can be used to put the power source in the activated or deactivated states and can be used to render the power source inoperable simply by pivoting the first mechanism member in the second pivoting direction to the stop position. Thus, due to these features, the actuator mechanism can be used for fulfilling all these purposes in a simple, reliable, ergonomic, user-friendly, and intuitive manner. Furthermore, since the actuator mechanism can be used for fulfilling all these purposes, conditions are provided for alleviating packing problems on the handheld power tool. Moreover, a handheld power tool is provided having conditions and characteristics suitable for being manufactured and assembled in a cost-efficient manner.

Furthermore, since the locking mechanism allows the first mechanism member to pivot in the second pivoting direction also when the button unit is in the locking position, the power source can be rendered inoperable in a simple, quick, and reliable manner simply by pivoting the first mechanism member to the stop position using the button unit.

Optionally, the power source is an internal combustion engine comprising an ignition system, and wherein the switch is configured to render the ignition system of the internal combustion engine inoperable upon being triggered. Thereby, a handheld power tool is provided in which the power source is rendered inoperable in an efficient and reliable manner when the first mechanism member is pivoted from the deactivating position in the second pivoting direction to the stop position.

Optionally, the handheld power tool is a chainsaw or a power cutter. Thereby, a chainsaw or power cutter is provided having at least some of the above mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a handheld power tool according to some embodiments,

FIG. 2a illustrates an actuator mechanism of the handheld power tool illustrated in FIG. 1,

FIG. 2b illustrates the actuator mechanism illustrated in FIG. 2a in which a button unit has been moved to an unlocking position and a first mechanism member has been pivoted from a deactivating position to an activating position,

FIG. 2c illustrates the actuator mechanism illustrated in FIG. 2a in which the first mechanism member has been pivoted from the deactivating position to a stop position,

FIG. 3a illustrates a cross section of the actuator mechanism illustrated in FIG. 2a,

FIG. 3b illustrates the cross section of the actuator mechanism illustrated in FIG. 3a in which the button unit has been moved to the unlocking position and the first mechanism member has been pivoted from the deactivating position to the activating position, and

FIG. 3c illustrates the actuator mechanism illustrated in FIG. 3a in which the first mechanism member has been pivoted from the deactivating position to the stop position.

### DETAILED DESCRIPTION

Aspects of the present invention will now be described more fully. Like reference signs refer to like elements throughout. Well-known functions or constructions will not necessarily be described in detail for brevity and/or clarity.

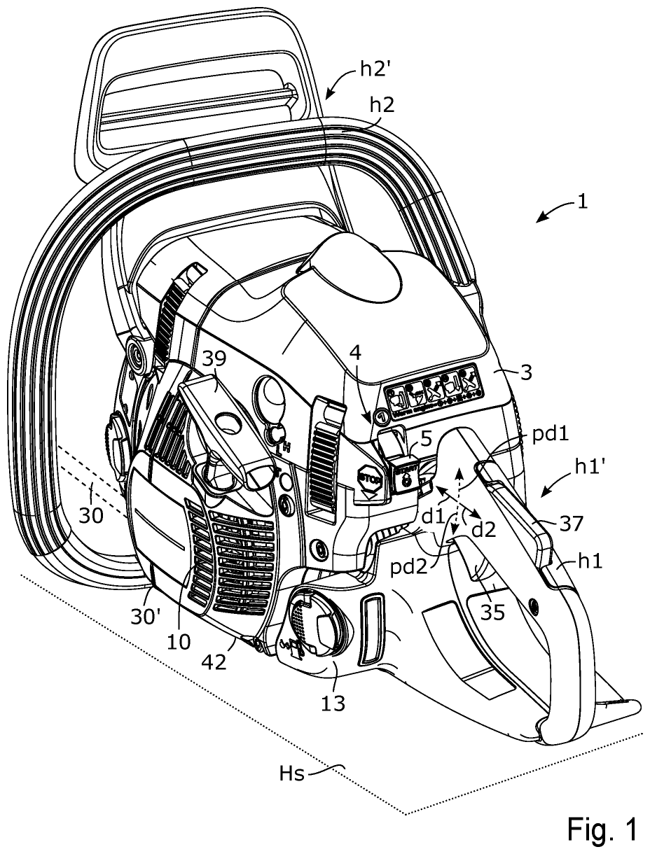

FIG. 1 illustrates a handheld power tool 1 according to some embodiments of the present disclosure. The handheld power tool 1 comprises a tool body 3 and a first and a second handle h1, h2 attached to the tool body 3. The second handle h2 is separate from the first handle h1 and is arranged at a distance from the first handle h1. The handheld power tool 1 is configured to be supported via each of the first and second handles h1, h2 during operation of the handheld power tool 1. In other words, the handheld power tool 1 is configured to be supported by two hands of a user during operation of the handheld power tool 1, i.e., is configured to be supported by one hand grabbing the first handle h1 and the other hand grabbing the second handle h2. According to further embodiments, the handheld power tool 1 may comprise one handle only.

The handheld power tool 1 comprises a tool 30 and a power source 10 configured to power the tool 30. According to the illustrated embodiments, the power source 10 is arranged in the tool body 3. Moreover, according to the illustrated embodiments, the handheld power tool 1 is a chainsaw comprising a tool 30 in the form of a cutting chain movably arranged around a guide bar. In FIG. 1, a portion of the cutting chain is schematically indicated in dashed lines. The power source 10 is configured to rotate the cutting chain around the guide bar during operation of the power source 10.

According to further embodiments, the handheld power tool 1, as referred to herein, may be another type of handheld power tool 1, such as for example a power cutter, a circular saw, a trimmer, a hedge trimmer, a multi-tool, or the like. Obviously, according to such embodiments, the handheld power tool 1 may comprise another type of tool 30 than a cutting chain, such as for example a circular saw blade, a trimmer head, a hedge trimmer cutting assembly, or the like.

According to the illustrated embodiments, the power source 10 of the handheld power tool 1 is an internal combustion engine. In more detail, according to the illustrated embodiments, the power source 10 is a small sized two-stroke internal combustion engine. The handheld power tool 1 comprises a fuel tank 13 configured to store fuel which is supplied to the internal combustion engine during operation thereof.

According to some further embodiments, the handheld power tool 1 may comprise another type of power source 10, such as a small sized four stroke internal combustion engine or an electric motor. The term “small sized” in this context may encompass that the internal combustion engine has an engine displacement of less than 250 cubic centimetres. According to embodiments in which the power source 10 comprises an electric motor, the handheld power tool 1 may comprise an electric battery for supplying electricity to the electric motor during operation thereof. As an alternative, or in addition, the handheld power tool 1 may comprise another type of device for supplying electricity to the electric motor during operation thereof, such as an electrical connector for connecting the electric motor to an electric power cord.

According to the illustrated embodiments, the first handle h1 is a rear handle arranged at a rear portion of the handheld power tool 1 and the second handle h2 is a so-called front handle. According to the illustrated embodiments, the second handle h2 is attached to the tool body 3 of the handheld power tool 1 at a region of a tool portion 30′of the handheld power tool 1. The tool portion 30′is a portion of the handheld power tool 1 to which the tool 30 of the handheld power tool 1 is connected. In other words, according to the illustrated embodiments, the second handle h2 of the handheld power tool 1 is arranged closer to the tool 30 of the handheld power tool 1 than the first handle h1. Moreover, the second handle h2 is arranged at a position between the tool 30 of the handheld power tool 1 and the first handle h1 of the handheld power tool 1.

The first handle h1 comprises a gripping portion h1′ configured to be gripped by a hand of a user during operation of the handheld power tool 1. Likewise, the second handle h2 comprises a gripping portion h2′ configured to be gripped by a hand of a user during operation of the handheld power tool 1. The second handle h2 is formed by an elongated curved-shaped body allowing a user to grip the gripping portion h2′ of the second handle h2 from various directions in a convenient manner which allows a user to operate the handheld power tool 1 at different orientations relative to the gravitational field in a convenient and safe manner.

The handheld power tool 1 comprises a throttle actuator 35. According to the illustrated embodiments, the throttle actuator 35 is arranged on the first handle h1 such that the throttle actuator 35 can be actuated by one or more fingers of a hand of a user when the hand of the user is gripping the gripping portion h1′ of the first handle h1. According to further embodiments, the throttle actuator 35 may be arranged at a region of the first handle h1 such that the throttle actuator 35 can be actuated by one or more fingers of a hand of a user when the hand of the user is gripping the gripping portion h1′ of the first handle h1.

According to the illustrated embodiments, the throttle actuator 35 is operably connected to a throttle valve of an air inlet system of the internal combustion engine. A power output of the internal combustion engine can thereby be regulated via the throttle actuator 35. According to further embodiments, the throttle actuator 35 may be operably connected to another type of device or system of the power source 10 for regulating the power output of the power source 10. For example, in embodiments in which the power source 10 comprises an electric motor, the throttle actuator 35 may be operably connected to power electronics for regulating the power output of the electric motor.

In FIG. 1, the handheld power tool 1 is illustrated as positioned in a usual upright parking position on a flat horizontal support surface Hs. When the handheld power tool 1 is positioned in the usual upright parking position on a flat horizontal support surface Hs, a bottom side 42 of the handheld power tool 1 is resting, i.e., is abutting, against the flat horizontal support surface Hs.

The first and second handles h1, h2 of the handheld power tool 1 can be accessed in an easy manner when the handheld power tool 1 is positioned in the usual upright parking position on the flat horizontal support surface Hs because the intended grabbing directions of the gripping portions h1′, h2′ of the first and second handles h1, h2 are substantially perpendicular to the flat horizontal support surface Hs when the handheld power tool 1 is positioned in the usual upright parking position on the flat horizontal support surface Hs.

The reason for the use of the word “usual” herein in the expression “usual upright parking position” is that the handheld power tool 1 could possibly be positioned on a flat horizontal support surface Hs in another orientation relative to the flat horizontal support surface Hs, such as for example laid on the side on the flat horizontal support surface Hs. However, if so, the intended grabbing directions of the gripping portions h1′, h2′ of the first and second handles h1, h2, will not be substantially perpendicular to the flat horizontal support surface Hs. Moreover, if so, the bottom side 42 of the handheld power tool 1 will apparently not rest against the flat horizontal support surface Hs.

According to embodiments herein, the handheld power tool 1 comprises an actuator mechanism 4 arranged on the tool body 3. According to the illustrated embodiments, the actuator mechanism 4 is arranged on a portion the tool body 3 located adjacent to the first handle h1. The actuator mechanism 4 is configured to allow a user to put the power source 10 in an activated or deactivated state, as is further explained herein.

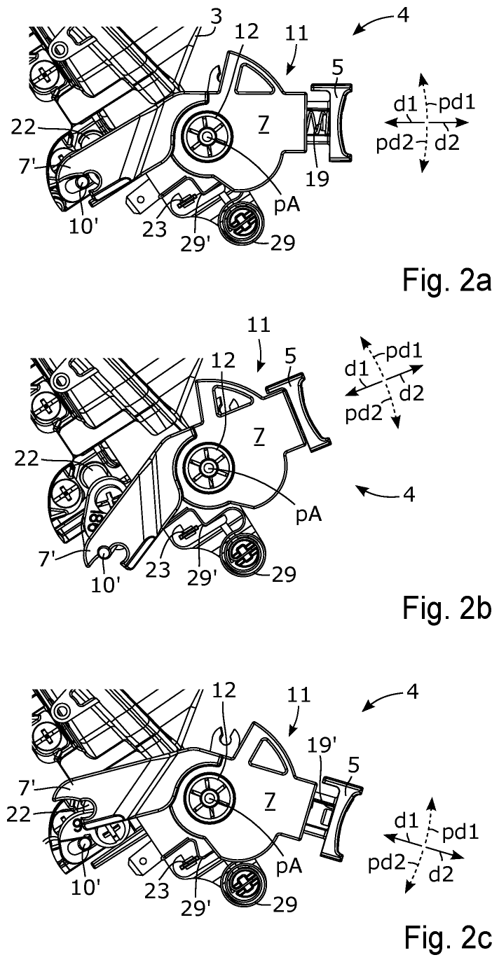

FIG. 2a illustrates the actuator mechanism 4 of the handheld power tool 1 illustrated in FIG. 1. Moreover, in FIG. 2a, a portion of the tool body 3 and a portion 10′of the power source of the handheld power tool can be seen. Below, simultaneous reference is made to FIG. 1 and FIG. 2a, if not indicated otherwise.

The actuator mechanism 4 comprises a first mechanism member 11. The first mechanism member 11 comprises a button unit 5 and a guide unit 7. The button unit 5 is slidably arranged relative to the guide unit 7 from a locking position towards an unlocking position along a first direction d1. As seen in these figures, the first direction d1 is pointing in a direction towards the tool body 3. In FIG. 1 and FIG. 2b, the button unit 5 is illustrated in the locking position relative to the guide unit 7. The actuator mechanism 4 further comprises a second mechanism member 12 attached to the tool body 3.

The first mechanism member 11 is pivotally attached to the second mechanism member 12 around a pivot axis pA between a deactivating position and an activating position. In other words, the first mechanism member 11 is pivotally attached to tool body 3 via the second mechanism member 12. In FIG. 1 and FIG. 2b, the first mechanism member 11 is illustrated in the deactivating position.

The first mechanism member 11 is locked from pivoting in a first pivoting direction pd1 relative to the second mechanism member 12 around the pivot axis pA when the first mechanism member 11 is in the deactivating position and the button unit 5 is in the locking position, as is further explained herein.

The first mechanism member 11 is operably connected to a portion 10′of the power source 10 such that the power source 10 is put in an at least partially deactivated state when the first mechanism member 11 is positioned in the deactivating position and such that the power source 10 is put in an activated state when the first mechanism member 11 is positioned in the activating position.

As mentioned, according to the illustrated embodiments, the power source 10 is an internal combustion engine. Moreover, according to the illustrated embodiments, the portion 10′ of the power source 10 is a portion of a choke valve actuator 22. The choke valve actuator 22 is connected to the choke valve of the internal combustion engine. According to these embodiments, the first mechanism member 11 is operably connected to the choke valve via the choke valve actuator 22 such that the choke valve assumes an open state when the first mechanism member 11 is in the deactivating state and such that the choke valve assumes a closed state when the first mechanism member 11 is in the activating state.

As understood from the above, according to the illustrated embodiments, the activated state of the power source 10, as referred to herein, is a state in which the choke valve of the internal combustion engine is in the closed state. A closed choke valve significantly enhances the startability of an internal combustion engine because the flow of air is restricted by the choke valve which decreases the air/fuel ratio, i.e., increases the proportion of fuel in an air/fuel mixture supplied to a cylinder of the engine.

Moreover, as understood from the above, according to the illustrated embodiments, the deactivated state of the power source 10, as referred to herein, is a state in which the choke valve of the internal combustion engine is in the open state. An open choke valve significantly impairs the startability of an internal combustion engine because the flow of air is not restricted by the choke valve which causes relatively high air/fuel ratios, i.e., relatively low proportions of fuel in the air/fuel mixture supplied to a cylinder of the engine, which makes the engine difficult to start.

However, according to further embodiments, the deactivated state of the power source 10, as referred to herein, may be another type of state causing the power source 10 to be at least partially deactivated, such as not ready nor prepared for operation. Likewise, the activated state of the power source 10, as referred to herein, may be another type of state causing the power source 10 to be activated, i.e., ready and/or prepared for operation.

As mentioned, in FIG. 2a, the first mechanism member 11 is illustrated in the deactivating position and the button unit 5 is illustrated in the locking position. According to the illustrated embodiments, the actuator mechanism 4 comprises a resilient element 19 configured to bias the button unit 5 in a second direction d2 being opposite to the first direction d1. The second direction d2 points in a direction out from the tool body 3 of the handheld power tool 1. The second direction d2 is also indicated in FIG. 1.

According to the illustrated embodiments, the resilient element 19 is a coil spring. Therefore, the resilient element 19, as referred to herein, may also be referred to as a coil spring, a spring member, or the like. According to further embodiments, the actuator mechanism 4 may comprise another type of resilient element than a coil spring which is configured to bias the button unit 5 in a second direction d2 being opposite to the first direction d1.

The first and second mechanism members 11, 12 form a locking mechanism configured to lock the first mechanism member 11 from pivoting around the pivot axis pA in a first pivoting direction pd1 from the deactivating position when the button unit 5 is in the locking position and is configured to allow the first mechanism member 11 to pivot in the first pivoting direction pd1 from the deactivating position to the activating position when the button unit 5 is in the unlocking position.

In other words, in FIG. 2a, the first mechanism member 11 is locked from pivoting around the pivot axis pA in the first pivoting direction pd1 indicated in FIG. 2a from the deactivating position. This is because the button unit 5 is in the locking position relative to the guide unit 7.

FIG. 2b illustrates the actuator mechanism 4 illustrated in FIG. 2a in which the button unit 5 has been moved to the unlocking position and the first mechanism member 11 has been pivoted, i.e., rotated, around the pivot axis pA in the first pivoting direction pd1 from the deactivating position to the activating position.

That is, in comparison to FIG. 2a, FIG. 2b illustrates relative positions of the components of the actuator mechanism 4 obtained when a user has pressed the button unit 5 in the first direction d1 to move the button unit 5 relative to the guide unit 7 from the locking position to the unlocking position and then pivoted the first mechanism member 11 from the deactivating position to the activating position by applying a force onto the button unit 5 in a direction substantially coinciding with the arrow “pd1” in FIG. 2a and FIG. 2b.

According to the illustrated embodiments, the first mechanism member 11 is operably connected to the portion 10′ of the choke valve actuator 22 via a portion 7′ of the guide member 7. According to the illustrated embodiments, the portion 7′ of the guide unit 7 is elongated and may also be referred to as an actuator portion, an actuator arm, or the like. In FIG. 2b, the portion 7′ of the guide member 7 has moved the portion 10′ of the choke valve actuator 22 such that the choke valve of the internal combustion engine has been moved from the open position to the closed position upon the pivoting movement of the first mechanism member 11 from the deactivating position illustrated in FIG. 2a to the activating position illustrated in FIG. 2b.

FIG. 2c illustrates the actuator mechanism 4 illustrated in FIG. 2a in which the first mechanism member 11 has been pivoted, i.e., rotated, around the pivot axis pA in a second pivoting direction pd2 from the deactivating position to a stop position. The second pivoting direction pd2 is opposite to the first pivoting direction pd1.

According to the illustrated embodiments, the locking mechanism formed by the first and second mechanism members 11, 12 allows the first mechanism member 11 to pivot from the deactivating position in the second pivoting direction pd2 regardless of the position of the button unit 5 relative to the guide unit 7, i.e., regardless of whether the button unit 5 is in the unlocking position or in the locking position relative to the guide unit 7.

According to the illustrated embodiments, the actuator mechanism 4 comprises a switch 23. The switch 23 is configured to be triggered when the first mechanism member 11 is pivoted from the deactivating position in the second pivoting direction pd2 to the stop position.

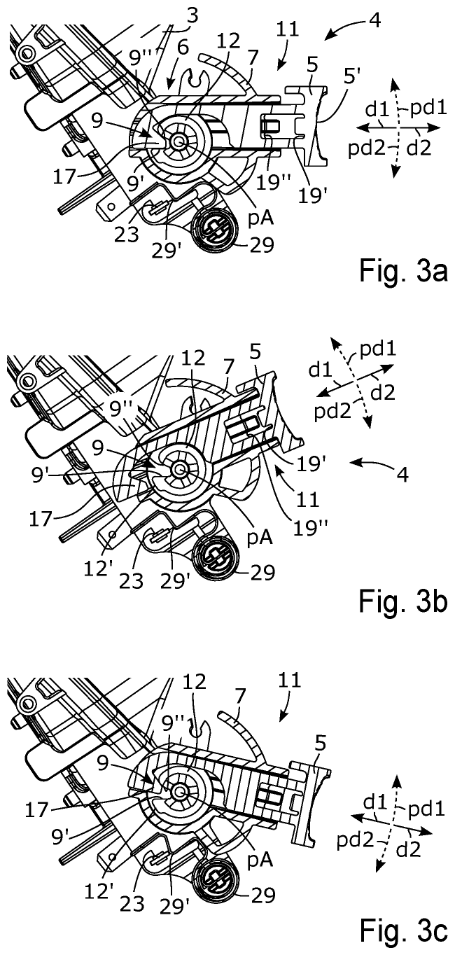

The features, functions, and advantages of this aspect is further explained with reference to FIG. 3c below. In FIG. 2c, the resilient element 19 of the actuator mechanism 4 has been omitted for reasons of brevity. Instead, a first abutment portion 19′ for the resilient element 19 illustrated in FIG. 2a has been indicated. In other words, in FIG. 2a, the resilient element 19 abuts against the first abutment portion 19′indicated in FIG. 2c.

FIG. 3a illustrates a cross section of the actuator mechanism 4 illustrated in FIG. 2a. In FIG. 3a, the cross section is made in a plane perpendicular to the pivot axis pA of the first mechanism member 11. Moreover, in FIG. 3a, a portion of the tool body 3 can be seen. However, in FIG. 3a, the portion 10′ of the power source, including the portion 10′ of the choke valve actuator 22, and the portion 7′ of the guide unit 7 of the first mechanism member 11 have been omitted in FIG. 3a for reasons of brevity and clarity. Moreover, in FIG. 3a, the resilient element 19 of the actuator mechanism 4 has been omitted for reasons of brevity. Instead, a second abutment portion 19″ and the first abutment portion 19′ for the resilient element 19 illustrated in FIG. 2a have been indicated.

As seen in FIG. 3a, the first abutment portion 19′ is arranged in the button unit 5 and the second abutment portion 19″ is arranged on the guide unit 7. A resilient element, such as the resilient element 19 illustrated in FIG. 2a, is configured to apply a separating force between the first and second abutment portions 19′, 19″. In this manner, the button unit 5 is biased in the second direction d2 relative to the guide unit 7 by the biasing force of the resilient element.

In FIG. 3a, the button unit 5 is illustrated in the locking position relative to the guide unit 7 and the first mechanism member 11 is illustrated in the deactivating position. In other words, in FIG. 3a, the components of the actuator mechanism 4 are illustrated in the same relative positions as in FIG. 2a.

In FIG. 3a, the locking mechanism 6 formed by the first and second mechanism members 11, 12 is indicated. As mentioned, the locking mechanism 6 is configured to lock the first mechanism member 11 from pivoting around the pivot axis pA in the first pivoting direction pd1 from the deactivating position when the first mechanism member 11 is in the deactivating position and the button unit 5 is in the locking position relative to the guide unit 7.

According to the illustrated embodiments, the locking mechanism 6 is formed by a protrusion 17 arranged on the button unit 5 and a recess 9 arranged on the second mechanism member 12. As seen in FIG. 3a, the protrusion 17 is configured to protrude into the recess 9 when the button unit 5 is in the locking position to thereby lock the first mechanism member 11 from pivoting around the pivot axis pA in the first pivoting direction pd1. In more detail, according to the illustrated embodiments, the locking mechanism 6 is configured to lock the first mechanism member 11 from pivoting around the pivot axis pA in the first pivoting direction pd1 by an abutting contact between the protrusion 17 and a first side wall 9′ of the recess 9 when the button unit 5 is in the locking position relative to the guide unit 7.

In this manner, the first mechanism member 11 cannot be pivoted from the deactivating position to the activating position when the button unit 5 is in the locking position relative to the guide unit 7.

The protrusion 17 arranged on the button unit 5 is configured to be moved out from the recess 9 when the button unit 5 is moved along the first direction d1 to the unlocking position. When the protrusion 17 has been moved out from the recess 9, the first mechanism member 11 is free to be pivoted in the first pivoting direction pd1 from the deactivating position to the activating position.

FIG. 3b illustrates the cross section of the actuator mechanism 4 illustrated in FIG. 3a in which the button unit 5 has been moved to the unlocking position relative to the guide unit 7 and the first mechanism member 11 has been pivoted, i.e., rotated, around the pivot axis pA in the first pivoting direction pd1 relative to the second mechanism member 12 from the deactivating position to the activating position.

That is, in comparison to FIG. 3a, FIG. 3b illustrates relative positions of the components of the actuator mechanism 4 obtained when a user has pressed the button unit 5 in the first direction d1 to move the button unit 5 relative to the guide unit 7 from the locking position to the unlocking position and then pivoted the first mechanism member 11 from the deactivating position to the activating position by applying a force onto the button unit 5 in a direction substantially coinciding with the arrow “pd1” in FIG. 3a and FIG. 3b.

Accordingly, in FIG. 3b, the button unit 5 is illustrated in the unlocking position relative to the guide unit 7 and the first mechanism member 11 is illustrated in the activating position relative to the second mechanism member 12. In other words, in FIG. 3b, the components of the actuator mechanism 4 are illustrated in the same relative positions as in FIG. 2b.

In FIG. 3b, the protrusion 17 of the button unit 5 has been moved out from the recess 9 upon the movement of the button unit 5 along the first direction d1 indicated in FIG. 3a. Moreover, the first mechanism member 11 has been pivoted around the pivot axis pA in the first pivoting direction pd1.

Since the first direction d1, as referred to herein, relates to a movement direction of the button unit 5 relative to the guide unit 7, and since each of the button unit 5 and the guide unit 7 is comprised in the first mechanism member 11, the first direction d1 changes when the first mechanism member 11 is pivoted around the pivot axis pA. That is, as can be seen in FIG. 3b, the first direction d1 is different from the first direction d1 illustrated in FIG. 3a. However, also the first direction d1 illustrated in FIG. 3b points in a direction towards the tool body 3 of the handheld power tool. Moreover, as mentioned above, the first mechanism member 11 is locked from pivoting in the first pivoting direction pd1 until the button unit 5 has been moved to the unlocking position relative to the guide unit 7. Therefore, according to the illustrated embodiments, the button unit 5 moves from the locking position to the unlocking position relative to the guide unit 7 along a first direction d1 according to FIG. 3a before the first mechanism member 11 can pivot from the deactivating position.

As clearly seen in FIG. 3b, the relative position between the first and second abutment portions 19′, 19″ for the resilient member is smaller when the button unit 5 is in the unlocking position relative to the guide unit 7 as compared to when the button unit 5 is in the locking position relative to the guide unit 7 illustrated in FIG. 3a. In other words, a resilient element, such as a resilient element 19 illustrated in FIG. 2a, placed between the first and second abutment portions 19′, 19″ becomes compressed upon movement of the button unit 5 relative to the guide unit 7 in the first direction d1.

In FIG. 3b, the button unit 5 is illustrated in a position relative to the guide unit 7 in which the button unit 5 is fully pressed relative to the guide unit 7 and in a position obtained when an external force having a magnitude greater than the biasing force of the resilient element still is acting on the button unit 5 in the first direction d1 indicated in FIG. 3b. Such an external force may be obtained by a pressing force of one or more fingers of the user. When the first mechanism member 11 is pivoted to the activating position illustrated in FIG. 3b and the external force acting on the button unit 5 is released, the button unit 5 moves a short distance in the second direction d2 indicated in FIG. 3b to a position in which an abutting contact is obtained between a portion of the protrusion 17 and a surface 12′of the second mechanism member 12. In this manner, the button unit 5 is retained in the unlocking position by the abutting contact between the protrusion 17 and the surface 12′of the second mechanism member 12 when the first mechanism member 11 is in the activating position.

However, a user can pivot the first mechanism member 11 from the activating position in the second pivoting direction pd2 by applying a force onto the button unit 5 in a direction substantially coinciding with the arrow “pd2” in FIG. 3a and FIG. 3b. The biasing force of the resilient element of the button unit 5 in the second direction d2 moves the button unit 5 from the unlocking position to the locking position when the first mechanism member 11 reaches the deactivating position illustrated in FIG. 3a.

As mentioned, the locking mechanism 6 formed by the first and second mechanism members 11, 12 allows the first mechanism member 11 to pivot from the deactivating position in the second pivoting direction pd2 also when the button unit 5 is in the locking position.

FIG. 3c illustrates the actuator mechanism 4 illustrated in FIG. 3a in which the first mechanism member 11 has been pivoted, i.e., rotated, around the pivot axis pA in the second pivoting direction pd2 from the deactivating position to the stop position.

As is indicated in FIG. 3c, the recess 9 of the second mechanism member 12 comprises a second side wall 9″. The second side wall 9″ is opposite to the first side wall 9′. As seen in FIG. 3a and FIG. 3b, the first side wall 9′ is substantially straight and the protrusion has a substantially straight side surface which faces the first side wall 9′ when the first mechanism member 11 is in the deactivating position and the button unit 5 is in the locking position as is illustrated in FIG. 3a. In this manner, the first mechanism member 11 is locked from pivoting in the first pivoting direction pd1 around the pivot axis pA by the abutting contact between the straight side surface of the protrusion 17 and the first side wall 9′ when the first mechanism member 11 is in the deactivating position and the button unit 5 is in the locking position.

However, as seen in in FIG. 3a-FIG. 3c, the second side wall 9″ of the recess 9 of the second mechanism member 12 is curved and the side surface of the protrusion 17 which faces the second side wall 9″ has an inclination allowing the protrusion 17 to be moved out of the recess 9 when the first mechanism member 11 is pivoted from the deactivating position illustrated in FIG. 3a towards the stop position illustrated in FIG. 3b.

In other words, according to the illustrated embodiments, the abutting contact between the second side surface 9″ of the recess 9 and the protrusion 17 forces the protrusion 17 out of the recess when the first mechanism member 11 is pivoted from the deactivating position illustrated in FIG. 3a towards the stop position illustrated in FIG. 3b. During this movement, the button unit 5 is forced to move along the first direction d1. Thereby, a resilient member placed between the first and second abutment portions 19′, 19″ is compressed upon pivoting of the first mechanism member 11 from the deactivating position towards the stop position. Moreover, due to the curved second side wall 9″ and the inclination of the side of the protrusion 17 facing the second side wall 9″, a resilient member placed between the first and second abutment portions 19′, 19″ biases the first mechanism member 11 from the stop position in a direction towards the deactivating position.

As seen in in FIG. 3a-FIG. 3c, according to the illustrated embodiments, the actuator mechanism 4 comprises a spring member 29. According to the illustrated embodiments, a portion of the first mechanism member 11 is configured to abut against the spring member 29 upon pivoting of the first mechanism member 11 from the deactivating position illustrated in FIG. 3a towards the stop position illustrated in FIG. 3b. In more detail, according to the illustrated embodiments, this portion of the first mechanism member 11 is a portion of the guide unit 7. The abutting contact between the spring member 29 and the portion of the first mechanism member 11 biases the first mechanism member 11 towards the deactivated position when the first mechanism member 11 is pivoted therefrom in the second pivoting direction pd2.

As mentioned, the actuator mechanism 4 comprises a switch 23 configured to be triggered when the first mechanism member 11 is pivoted from the deactivating position in the second pivoting direction pd2 to the stop position. According to the illustrated embodiments, the switch 23 is configured to be triggered by a portion 29′of the spring member 29 when the first mechanism member 11 is pivoted to the stop position.

According to the illustrated embodiments, the switch 23 is configured to render the power source 10 inoperable upon being triggered. As mentioned, according to the illustrated embodiments, the power source 10 is an internal combustion engine. The internal combustion engine comprises an ignition system configured to ignite an air/fuel mixture in a cylinder of the internal combustion engine. According to these embodiments, the switch 23 is configured to render the ignition system of the internal combustion engine inoperable upon being triggered. In this manner, the power source 10 is rendered inoperable in an efficient and reliable manner when the first mechanism member 11 is pivoted from the deactivating position in the second pivoting direction pd2 to the stop position illustrated in FIG. 3c.

According to further embodiments, the switch 23 may be configured to render the power source 10 inoperable in another manner upon being triggered. For example, in embodiments in which the power source 10 comprises an electric motor, the switch 23 may be configured to render the power source 10 inoperable by rendering power electronics of the handheld power tool 1 inoperable.

According to the illustrated embodiments, each of the button unit 5 and the guide unit 7 of the first mechanism member 11 is made from one piece of polymeric material. According to further embodiments, one or both of the button unit 5 and the guide unit 7 may be formed by another type of material, such as metal, and/or may be provided by the assembly of two or more separate parts. Moreover, according to the illustrated embodiments, the second mechanism member 12 is formed by a polymeric material. However, according to further embodiments, the second mechanism member 12 may be formed by another type of material, such as metal.

The following is explained with simultaneous reference to FIG. 1-FIG. 3c, if not indicated otherwise. According to the illustrated embodiments, the first direction d1 is perpendicular to the pivot axis pA. According to further embodiments, the first direction d1 may be substantially perpendicular to the pivot axis pA.

In FIG. 3a, a button portion 5′of the button unit 5 is indicated. The button portion 5′ of the button unit 5 faces a user. According to the illustrated embodiments, the actuator mechanism 4 is arranged such that the button portion 5′ of the button unit 5 is moved in a direction towards the pivot axis pA when the button unit 5 is moved along the first direction d1 and such that the button portion 5′ of the button unit 5 is moved in a direction away from the pivot axis pA when the button unit 5 is moved along the second direction d2.

Furthermore, according to the illustrated embodiments, the pivot axis pA of the first mechanism member 11 is parallel to the bottom side 42 of the handheld power tool 1. In other words, the pivot axis pA of the first mechanism member 11 is parallel to a flat horizontal support surface Hs when the handheld power tool 1 is positioned in the usual upright parking position on a flat horizontal support surface Hs as is illustrated in FIG. 1. According to further embodiments, the pivot axis pA of the first mechanism member 11 may be substantially parallel to the bottom side 42 of the handheld power tool 1.

Moreover, according to the illustrated embodiments, the actuator mechanism 4 is configured such that the button portion 5′ of the button unit 5 obtains a movement vector component pointing away from the flat horizontal support surface Hs when the first mechanism member 11 is pivoted from the deactivating position in the first pivoting direction pd1 and the handheld power tool 1 is positioned in the usual upright parking position on the flat horizontal support surface Hs. Similarly, according to the illustrated embodiments, the actuator mechanism 4 is configured such that the button portion 5′ of the button unit 5 obtains a movement vector component pointing towards the flat horizontal support surface Hs when the first mechanism member 11 is pivoted from the deactivating position in the second pivoting direction pd2 and the handheld power tool 1 is positioned in the usual upright parking position on the flat horizontal support surface Hs.

Thus, according to the illustrated embodiments, the first pivoting direction pd1 corresponds to an upward pivoting movement direction of the button portion 5′ of the button unit 5, whereas the second pivoting direction pd2 corresponds to a downward pivoting movement direction of the button portion 5′ of the button unit 5, as seen from the perspective of a user when the handheld power tool 1 is positioned in the usual upright parking position on a flat horizontal support surface Hs as is illustrated in FIG. 1.

As seen in FIG. 1, the handheld power tool 1 comprises a set of instructions. The set of instructions includes a symbol and the text “START” provided on the button portion of the button unit 5. Moreover, the set of instructions comprises more detailed instructions on the tool body 3 of the handheld power tool 1.

The handheld power tool 1 comprises a motor starter grip 39. The motor starter grip 39 is connected to a crankshaft of the internal combustion engine via a cord. In a starting procedure of the power source 10 of the handheld power tool 1, a user may press the button portion 5′ of the button unit 5 in the first direction d1 pointing towards the tool body 3 of the handheld power tool 1 and may pivot the first mechanism member 11 to the activating position by pivoting the button portion 5′ of the button unit 5 in a direction upwards according to the above. As a result, the choke valve of the internal combustion engine will be closed. Then, the user may pull motor starter grip 39 to start the internal combustion engine.

The handheld power tool 1 according to the illustrated embodiments further comprises a safety switch actuator 37 arranged on the gripping portion h1′ of the first handle h1. The safety switch actuator 37 must be actuated before allowing regulation of the power output of the internal combustion engine via the throttle actuator 35. The safety switch actuator 37 may mechanically prevent movement of the throttle actuator 35 when being in an unactuated position.

Accordingly, after starting the internal combustion engine, the user may grip each of the gripping portions h1′, h2′ of the first and second handles to actuate the safety switch actuator 37 and may control the power output of the internal combustion engine 10 using the throttle actuator 38.

Then when a user wants to turn off the internal combustion engine, the user may simply move the first mechanism member 11 to the stop position by applying a force onto the button portion 5′ of the button unit 5 in a direction downwards according to the above. As seen in FIG. 1, the set of instructions comprises a symbol and the text “STOP” provided on the tool body 3 to the left of the button unit 5 indicating to a user that this is procedure possible.

The wording “substantially parallel to”, as used herein, may encompass that the angle between the objects referred to is less than 10 degrees, or is less than 7 degrees.

The wording “substantially perpendicular to”, as used herein, may encompass that the angle between the objects or vectors referred to is within the range of 80-100 degrees or is within the range of 83-97 degrees.

The wording “substantially coinciding with”, as used herein, may encompass that the angle between the objects referred to is less than 10 degrees, or is less than 7 degrees.

The wording “substantially straight”, as used herein, may encompass that the object referred to deviates less than 10% from the shape of a flat plane.

The wording “adjacent to”, as used herein, may encompass that the objects referred to is within 0.5-7 centimetres from each other.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A handheld power tool comprising:
a tool body,
an actuator mechanism arranged on the tool body, and
a power source for powering a tool of the handheld power tool, wherein the actuator mechanism comprises:
a first mechanism member comprising a button unit and a guide unit and
a second mechanism member attached to the tool body,
wherein the first mechanism member is pivotally attached to the second mechanism member around a pivot axis between a deactivating position and an activating position and is operably connected to a portion of the power source such that the power source is put in an at least partially deactivated state when the first mechanism member is positioned in the deactivating position and such that the power source is put in an activated state when the first mechanism member is positioned in the activating position,
wherein the first and second mechanism members form a locking mechanism configured to lock the first mechanism member from pivoting around the pivot axis in a first pivoting direction from the deactivating position when the button unit is in a locking position and is configured to allow the first mechanism member to pivot in the first pivoting direction from the deactivating position to the activating position when the button unit is in an unlocking position, and
wherein the button unit is slidably arranged relative to the guide unit from the locking position towards the unlocking position in a first direction pointing towards the tool body.

2. The handheld power tool according to claim 1, wherein the first direction is substantially perpendicular to the pivot axis.

3. The handheld power tool according to claim 1, wherein the locking mechanism is formed by a protrusion arranged on the button unit and a recess arranged on the second mechanism member.

4. The handheld power tool according to claim 3, wherein the protrusion is configured to protrude into the recess when the button unit is in the locking position to lock the first mechanism member from pivoting around the pivot axis in the first pivoting direction by an abutting contact between the protrusion and a first side wall of the recess and is configured to be moved out from the recess when the button unit is moved to the unlocking position to allow the first mechanism member to pivot around the pivot axis in the first pivoting direction

5. The handheld power tool according to claim 3, wherein the button unit is configured to be retained in the unlocking position by an abutting contact between the protrusion and a surface of the second mechanism member when the first mechanism member is in the activating position.

6. The handheld power tool according to claim 1, wherein the actuator mechanism comprises a resilient element configured to bias the button unit in a second direction being opposite to the first direction.

7. The handheld power tool according to claim 1, wherein the power source is an internal combustion engine comprising a choke valve, and wherein the portion of the power source is a choke valve actuator connected to the choke valve of the internal combustion engine.

8. The handheld power tool according to claim 1, wherein the locking mechanism allows the first mechanism member to pivot from the deactivating position in a second pivoting direction, being opposite to the first pivoting direction when the button unit is in the locking position.

9. The handheld power tool according to claim 1, wherein the actuator mechanism comprises a switch configured to be triggered when the first mechanism member is pivoted from the deactivating position in a second pivoting direction, being opposite to the first pivoting direction, to a stop position.

10. The handheld power tool according to claim 9, wherein the switch is configured to render the power source inoperable upon being triggered.

11. The handheld power tool according to claim 9, wherein the power source is an internal combustion engine comprising an ignition system, and wherein the switch is configured to render the ignition system of the internal combustion engine inoperable upon being triggered.

12. The handheld power tool according to claim 1, wherein the handheld power tool is a chainsaw or a power cutter.
